(19) United States
(12) Patent Application Publication
(10) Pub. No.: US 2018/0375815 A1
(43) Pub. Date: Dec. 27, 2018

(54) Send2Mobile Cloud Plus

(71) Applicants: Jeffrey Neil Dinardo, SR., Islip, NY (US); Jeffrey Neil Dinardo, JR., West Babylon, NY (US)

(72) Inventors: Jeffrey Neil Dinardo, SR., Islip, NY (US); Jeffrey Neil Dinardo, JR., West Babylon, NY (US)

(21) Appl. No.: 15/732,695

(22) Filed: Dec. 15, 2017

Related U.S. Application Data
(63) Continuation of application No. 14/545,891, filed on Jul. 2, 2015, now abandoned.
Application No. 14/545,891 is a continuation-in-part of application No. 13/998,801, filed on Dec. 9, 2013, now Pat. No. 9,218,613.

(51) Int. Cl. H04L 12/58; G06Q 30/02; H04W 4/21; G06Q 30/06; G06Q 20/36; H04L 29/06; G06F 21/62; H04L 12/18; H04L 29/08

(52) U.S. Cl. CPC H04L 51/24; G06Q 30/0261; H04W 4/21; G06Q 30/0633; G06Q 30/0641; G06Q 20/36; H04L 63/102; H04W 12/08; G06F 2221/2107; H04L 12/18; G06F 21/6263; H04L 67/1097; G06F 21/6218

(57) ABSTRACT

The present invention utilizes cloud-based remote Platform as a Service (PaaS) System, together with a short message service (SMS), multi-media message service (MMS) or enhanced messaging service (EMS) text messaging based platforms to create a near real time interactive communications and reverse marketing system, thereby providing merchants, retailers and or sellers the means to rapidly and effectively communicate with their respective customers via the customers' mobile computing devices facilitating the sale of a product or service. The merchant's cloud-based system, which comprises a microprocessor, memory, and communication interface permits the merchant to directly send to and receive messages from the customers' mobile computing device and to detect and to interface with native applications residing on the customers' mobile computing device, thereby allowing the customer to execute near real-time processes to request additional product information, make a bid or counter-offer for products or services or to immediately purchase products or services from the customers' mobile computing device. At the same time, the customer can maintain its own private portal within the merchants' cloud-based system, which allows the customers to store product information for future reference or future purchase, forward and share specific product information to friends via the social media network, communicate directly with the merchant with questions, comments or counter-offers concerning specific products or services or to purchase product or services via mobile payment systems native to the customers' mobile computing device.

### BACKGROUND OF INVENTION

### Field of Invention

This present invention relates to providing consumers direct access to enabled merchants and retailers through the consumer's mobile computing device and interaction via text messaging communication with a merchant or retailer's enabled remote cloud server, in order to permit the consumer to store and share product information and content, to communicate via connected and interfaced SMS/MMS/EMS platform directly to a merchant, retailer or seller of a product or service in order to make offers, counter-offers, bids or counter-bids for the purchase of products and/or services and to initiate immediate payment for products and/or services, through a “buy now” mobile wallet integrated and residing on the consumer's mobile computing device.

### Description of Related Art

The information provided in this background summary is only to assist with an understanding of the present invention. No determination has been made, and no assertion is made, as to whether any of the below might be applicable as prior art with regard to the present invention.

Each day, more and more information and content becomes available to the individual and each day, newer communications technologies are being developed to assist the individual in managing and processing the information and content available. In the present invention, a private cloud portal housed on an enabled merchant's remote cloud server is provided to the consumer in order to store content and information relevant to the merchant's products or services and to provide the consumer with the ability to download and share said content and information from the consumer's private cloud portal, anytime and anywhere using the consumer's mobile computing device.

Existing public cloud services typically involve a structure in which a server with a fixed infrastructure is accessed by clients through an electronic device, and using a fixed internet identifier such as an IP address or domain number. These public cloud storage systems utilize an existing Network Attached Storage (NAS) system, wherein the NAS system uploads or downloads and shares content and information by using a plurality of electronic devices such as iPhone, iPad, smartphone, PC, tablet PC and smart TV. In the existing public cloud services, the cloud servers are shared by multiple users and therefore privacy and security problems occur.

Accordingly, there is a need to develop a personal cloud method and system, whereby the consumer can securely store content and information, both personal and financial, and only after proper identification and authentication protocols are initiated and followed can access his/her stored content and information, further upload content and information, download content and information, share content and information and initiate an interaction with merchants, retailers and sellers, such as requests for further information, payment, offers of purchase, bids, counter-bids and counter-offers for products and/or services, prior identified for purchase by the consumer. A plurality of these actions are initiated through a connected and interfaced SMS/MMS/EMS platform, connected to an enabled merchant's private cloud system and the consumer's mobile computing device.

The present invention addresses utilization by a merchant of a private cloud method and system and offers consumers private, secure access to individualized private portal accounts, which contain the personal content and information previously stored in these accounts by the consumer for later reference, download, sharing or further interactions with the merchant of product and services, such as requests for specific product information, payment for products and services; offers to purchase; offers to bid; counter-offers; counter-bids, which will be effectuated via a connected and interfaced SMS/MMS/EMS platform within the private cloud system and which will detect and interface with native applications residing on the consumer's mobile computing device.

### SUMMARY OF THE INVENTION

Aspects of the present invention are to address at least the above-mentioned problems and/or disadvantages and to provide the advantages described below. Accordingly, an aspect of the present invention is to provide a user with private, secure access via the consumer's mobile computing device, to personal cloud storage, through the establishment of a private portal account, residing and housed on the enabled merchant's private cloud server. In accordance with an aspect of the present invention, after the consumer has completed the log in process and has been properly identified and authenticated, the consumer is granted access to its private portal account wherein the consumer has direct access to all information and content previously stored by the consumer in its private portal account, such as a listing of all products and services previously sent to the private portal by the consumer, via an enabled Send2Mobile merchant's private cloud server and consumer's mobile computing device. The consumer may opt to send product information to its portal account by clicking on the link or icon or button provided on the Send2Mobile enabled mobile website product page. Once the User has acted to click on the Send2Mobile link, button or icon located on the product page of the merchant's Send2Mobile enabled mobile website, the Send2Mobile system then pushes the chosen product page to the consumer's private portal housed on the merchant's enabled private cloud server for storage and future reference and/or action. Further actions that the User can execute directly from its private portal include, review of its saved listings; downloading and sharing favorite products with other contacts and friends or payment for a product previously chosen and stored via an integrated digital wallet solution native to the consumer's mobile computing device. The consumer's private portal on the enabled merchant's private cloud server contains the consumer's billing and shipping information and encrypted payment information, so that once the consumer elects to purchase a previously stored product, with the click of one button, the interface on the enabled merchant's cloud server, can initiate a charge to the consumer's stored credit card and all of the pertinent order and payment details are forwarded to the enabled merchant's private cloud server for authentication and purchase authorization. Simultaneously, via an integrated SMS/MMS EMS platform, the Send2Mobile system will text a message to the consumer's mobile computing device, which will also contain all of the consumer's pertinent order and payment details.

According to another aspect of the present invention, is the enrollment of Send2Mobile enabled merchants' mobile websites. Once a merchant has successfully applied and enrolled with the Send2Mobile system, the enrollee will be supplied with Send2Mobile system coding to be added to their respective mobile websites. This Send2Mobile coding when added to the respective enrollees' websites, will integrate the features offered by the Send2Mobile system; such as adding a “send to me’ icon, which when selected will push a product page to a consumer's private portal on the enabled merchant's private cloud server, for storage and future reference and/or action; adding a “buy now” button or icon, which when selected, will permit the consumer to purchase the product immediately from their mobile computing device via an integrated mobile wallet; and adding a drop down menu icon onto the mobile website product page, which when selected will contain a plurality of events and/or inquiries that can be chosen by the consumer for inquiries to be sent through the Let Me Know function of the Send2Mobile system.

The drop down menu can be customized by the system enabled merchant to include a plurality of events such as new sales price of the product; the product now comes in newer models; the product is now re-stocked; the product is now offered in new colors and styles and so on. The enabled merchant's Send2Mobile system will have added code to its respective websites to detect the drop down menu events and to send text message replies to the consumer's mobile computing device via the integrated SMS/MMS/EMS platforms.

The Let Me Know function allows the consumer to communicate directly with the enabled Send2Mobile merchant, via an integrated SMS/MMS/EMS platform, which interfaces with the merchant's private cloud server. The consumer can then use the drop down menu to communicate directly with the enabled merchant in order perform such actions as: product specific inquiries; making an offer to purchase the product at a lesser price; placing a bid or counter-bid for the product in a live auction environment; or choosing to immediately purchase the product via an integrated mobile wallet. The use of the Let Me Know function by the consumer enables the consumer to take a more pro-active role in the purchase process; it effectively creates a “reverse marketing” environment, wherein the consumer is informing the merchant what products or services they are ready to buy and under what conditions and what price they are willing to buy now.

Other aspects, advantages and salient features of the invention will become apparent to those skilled in the art from the following detailed descriptions, which, when take in conjunction with the annexed drawings, discloses various embodiments of the present invention.

### BRIEF DESCRIPTION OF DRAWINGS

FIG. 1 is a conceptual diagram of a mobile computing device which a buyer uses to interact with a seller's private cloud server enabled by the Send2Mobile system.

FIG. 2. is a conceptual diagram of the connection between a buyer's mobile computing device and a seller's website or mobile website enabled with the Send2Mobile system.

FIG. 3. is a conceptual diagram of a buyer's mobile computing device, which contains a native SMS messaging application that is detected by and interfaces with the seller's enabled private cloud server and receives a text number enabling direct communication between buyer and seller.

FIG. 4. is a conceptual diagram of the Send2Mobile Cloud Server, which hosts a Send2Mobile enabled seller's server account and includes a microprocessor, memory and communications interface.

FIG. 5. is a conceptual diagram of the private cloud router, which transmits the seller's message and information to an SMS aggregator for further transmission.

FIG. 6. is a conceptual diagram of the SMS aggregator or gateway, which receives a message and information from a seller's private cloud router and transmits the message and information via a seller's computing device to the buyer's mobile computing device.

FIG. 7. is a conceptual diagram of a seller's computing device from which the seller can communicate directly to the buyer's mobile computing device.

FIG. 8. is a conceptual diagram of the transmission of the seller's message and information via SMS text messaging directly to the buyer's mobile device.

FIG. 9. is a conceptual diagram of the transmission to and receipt by a buyer's mobile computing device of the SMS text message from a seller's private cloud server, which contains interface links from which a buyer can request additional product or service information, make an counter-offer to buy the product or service, make a bid on a product or service or immediately purchase a product or service through direct interface with the native mobile wallet application residing on a buyer's mobile computing device.

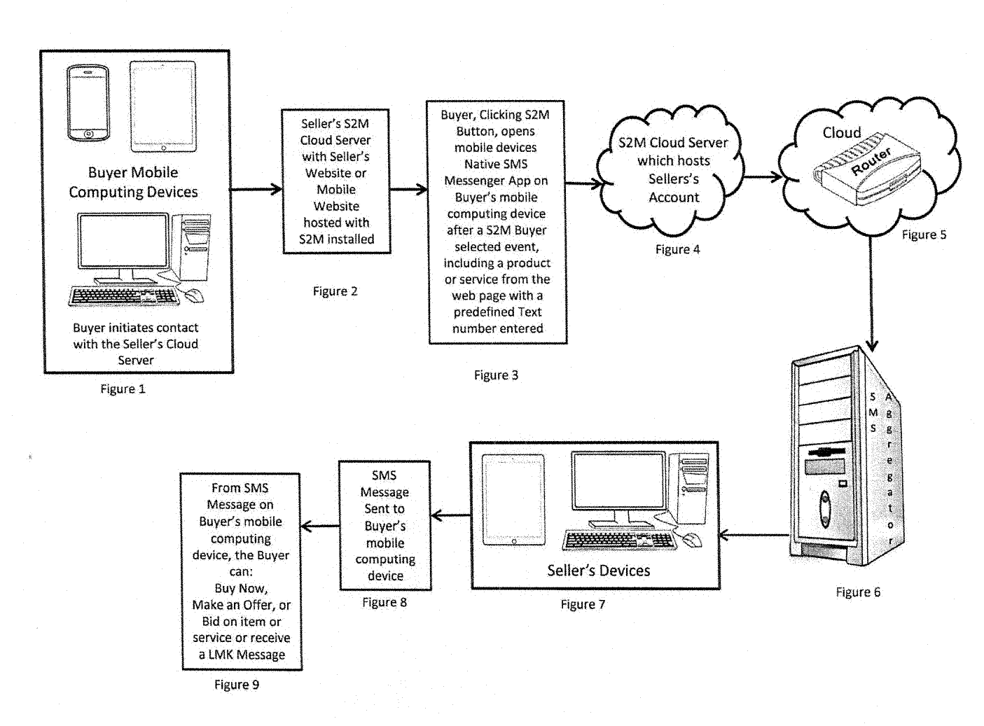

What is claimed is:

1. A system and method for facilitating the sale of a product or service via interactive text messaging communication with a customer's mobile computing device capable of sending and receiving text messages, comprising:
a buyer's mobile computing device which is associated with a mobile device number, and
a seller's dedicated private cloud server, which comprises a microprocessor, memory, and
a communications interface, programmed to perform the following method:
display a selectable icon on a seller's web-page, mobile web-page, in social media platform, and or advertisement of a product or service to purchase, buy now, stored in the memory of a seller's dedicated private cloud server, wherein when the icon is selected by a buyer from a buyer's mobile computing device:
cause the microprocessor to detect applications native to a buyer's mobile computing device and instructing the microprocessor to request permission to activate a buyer's native SMS/MMS or instant messaging applications on a buyer's mobile computing device allowing direct communication via SMS/MMS instant text messaging between a buyer and seller; Further, providing the buyer's configured event as displayed on seller's website further enabling the buyer and seller to interact via SMS directly from buyer's native mobile device:
cause the microprocessor to generate a text message to the buyer's mobile device including a display of an authentication code for a buyer to respond via SMS, mobile instant messaging text message to the seller's private cloud server;
cause the communication interface of the merchant's private dedicated cloud server to transmit the text message to a buyer's mobile computing device using the buyer's native SMS, instant text messaging applications on the buyer's mobile computing device;
receive, at the buyer's mobile computing device, the seller's generated text message including the authentication code, which when transmitted back to the seller's private cloud server by the buyer's mobile computing device causes the microprocessor to generate a text message response to buyer's mobile computing device containing a universal resource locator (URL), which when selected by the buyer causes an immediate purchase of the product or service or permits further interactive response with the seller's private cloud server.

2. The system according to claim 1, wherein the text message is a Short Message Service (SMS) message.

3. The system according to claim 1, wherein the text message is generated via instant messaging protocol.

4. The system according to claim 1, wherein the operation is sending a second text message from the buyer's mobile computing device to the seller's private cloud server in response to the received text message for further interaction.

5. The system according to claim 1, wherein the second text message generated from the buyer's mobile device requests a plurality of events or information of one or more of a change in price of a product, updated information regarding the availability of a product, availability of newer versions or models of a product, availability of a product having desired characteristics, a bid or counter-offer on the product, the item is sold, or an update on information relating to a product or service.

6. The system according to claim 5, wherein the seller's private cloud server receives the second text message from the buyer's mobile computing device and stores the request in the memory of the seller's private cloud server.

7. The system according to claim 5, wherein the seller's microprocessor determines that information is available to respond to the buyer's second text message request stored in the seller's private cloud server memory.

8. The system according to claim 5, wherein the seller's microprocessor generates an SMS/MMS or instant text message responding to the buyer's request and displaying a universal resource locator (URL), which when selected by the buyer causes either an immediate purchase or permits the buyer to enter a counter-offer or bid for the purchase of the product.

9. The system according to claim 8, wherein the seller's microprocessor generates an SMS/MMS or instant text message responding to the buyer's request and displaying a universal resource locator (URL), which when selected by the buyer permits the buyer to transmit the SMS/MMS or instant text message directly from buyer's mobile device to one or more social media channels via a Send2Mobile application gateway transmittal page.

10. The system according to claim 1, wherein a buyer via its mobile computing device can access a private buyer's portal provided by the seller and hosted on the seller's private cloud server.

11. The system according to claim 10, wherein a buyer can store and retrieve information from a private buyer's portal provided by the seller and hosted on the seller's private cloud server.

12. The system according to claim 10, wherein the buyer can retrieve and transmit information stored in a private buyer's portal to friends via SMS messaging, instant messaging or social media links.

13. The system according to claim 1, wherein the text message is a chatbot communication via a computer implemented method for conducting an automated conversation between a buyer and a seller's private cloud server.

14. The system according to claim 1, is programmed to detect applications native to a buyer's mobile computing device and instructing the microprocessor to request permission to activate a buyer's native SMS/MMS or instant messaging applications on a buyer's mobile computing device allowing direct communication via SMS/MMS and instant text messaging between a buyer and seller; Further, providing the buyer's configured event as displayed on seller's website further enabling the buyer and seller to interact via SMS directly from buyer's native mobile device.
